(19) United States
(12) Patent Application Publication
(10) Pub. No.: US 2025/0331975 A1
(43) Pub. Date: Oct. 30, 2025

(54) FACILITY FOR HIGH-SPEED PROCESSING OF NEWLY HATCHED BIRDS

(71) Applicant: EGG-CHICK AUTOMATED TECHNOLOGIES, LANDIVISIAU (FR)

(72) Inventors: Bertrand MALET, LANDIVISIAU (FR); Johan TARVYDAS, LANDIVISIAU (FR); Johann PENGLOAN, LANDIVISIAU (FR); William BOYER, LANDIVISIAU (FR)

(21) Appl. No.: 18/695,713

(22) PCT Filed: Sep. 29, 2022
(86) PCT No.: PCT/FR2022/051841

§ 371 Date: Oct. 9, 2024

(30) Foreign Application Priority Data
Sep. 29, 2021 (FR) FR2110240

(51) Int. Cl. A61D 1/02; A01K 45/00; A61D 7/00; B65G 15/30; B65G 39/12

(52) U.S. Cl. CPC A61D 1/025; A01K 45/00; A61D 7/00; B65G 15/30; B65G 39/12

(57) ABSTRACT

The invention relates to a facility for high-speed processing of newly hatched fowl.

According to the invention,
said facility comprises at least one first linear conveyor (10), which defines a conveying axis (11) along which a plurality of processing stations (13) are arranged,
at least some of said processing stations (13) being identical so that the fowl of a single first container in motion can receive the same processing by being shared across the various identical processing stations (13),
at least each one of said identical processing stations (13) comprising a chute (15) for conveying fowl thus processed to second containers (16),
said facility comprising stationary supports for supporting said second containers, which are placed level with a second conveyor (17) located under said first conveyor (10), so that each second container can be moved, when it is full, to said second conveyor (17) in order to be discharged.

### TECHNICAL FIELD

The present invention relates to a facility for high-speed processing of newly hatched fowl, in particular chicks.

### PRIOR ART

It is known in the field of avian farming to handle chicks from their first day to carry out various operations such as weighing them to assess their health condition as well as to inject one or more veterinary substances, for example subcutaneous vaccines.

In some operations, the chicks are handled manually, which requires the operator not only to have knowledge but also practice, which are essential to minimizing the stress of the live animal.

The chicks in a single batch, for example the one consisting of a container conveyed by a conveyor, are then typically processed on the same workstation by a single operator who places the chicks he has processed in another container as he goes so they can be discharged.

However, it can be seen that, regardless of the dexterity of this operator, the time necessary to process such a batch of live animals is relatively long.

Thus, and while many efforts have been made in recent years, in order to significantly increase the processing speeds of eggs to be hatched, with numbers that can be achieved today typically of 90,000 eggs per hour and more, the processing speeds of newly hatched chicks still remain low.

In addition, it can be seen that the design of the facilities for processing the chicks, which systematically comprises changes of direction, causes the chicks to undergo significant stress, or even to be subject to bruising and skeletal injuries during their transport.

However, compliance with the animal wellness standards is currently a major issue in all segments of the livestock industry.

Health issues among the personnel working in these facilities are also

encountered too frequently, such as the appearance of musculoskeletal disorders (MSD).

Moreover, it is known to administer vaccines to chicks at one day of age, or to chicks between one (1) and five (5) days of age, in order to immunize these animals against various illnesses during the first days of their lives.

These vaccines are necessary not only to ensure good health of these live animals, but also to guarantee suitable productions.

In order to process a large number of chicks simultaneously, it is known to expose these chicks, arranged in containers or baskets, in motion on conveyors, to fine water droplets containing the vaccine to be administered, these droplets being obtained by spraying. The direct contact of these chicks with the mist of droplets ensures their vaccination by the oculo-nasal route.

It is also known to pass these trays loaded with chicks, by means of conveyors, under nozzles ejecting drops of gel containing a vaccine, these drops adhering in contact for example being dyed with a color that is attractive to the chick. Vaccination of the chicks is then ensured by ingestion of drops of gel taken from the bodies of the surrounding chicks.

Such coloring also makes it possible to ensure that the product is taken correctly by simple visual inspection of the inside of the animal's mouth.

However, in order for these vaccines to be effective, on the one hand the container must be processed in its entirety, from the front to the rear thereof, and on the other hand the distribution of the droplets must be homogeneous over the entire container.

Also, the same vaccine volume must be continuously applied to each container.

However, since the supply of the nozzles with a dose of vaccine to be dispensed over a container is carried out from a predetermined storage volume, such as the volume of a syringe, the containers cannot run continuously under the fluid droplet dispensing apparatuses.

There is therefore a pressing requirement for a unit for processing newly hatched fowl, in particular chicks, the original design of which makes it possible to overcome the disadvantages of the prior art described above.

### SUBJECT MATTER OF THE INVENTION

The present invention aims to overcome the disadvantages of the background art by proposing a facility for processing newly hatched fowl, such as chicks, that is simple in its design and in its operating mode, ensuring high speeds, typically greater than 12,000 fowl per hour and more.

Another object of the present invention is such a facility for processing newly hatched fowl that respects the well-being of these live animals.

Yet another object of the present invention is such a facility for processing newly hatched fowl making it possible to reduce the risks for operators to develop musculoskeletal disorders (MSD).

Yet another object of the present invention is such a facility for processing newly hatched fowl making it possible to manage containers transported by a conveyor to expose their surface to droplets of one or more veterinary fluids and to guarantee homogeneous processing of all the fowl contained in these containers.

### DISCLOSURE OF THE INVENTION

To this end, the invention relates to a facility for high-speed processing of newly hatched fowl, said facility having an upstream end and a downstream end, said facility being intended to receive, at its upstream end, first containers wherein said live newly hatched fowl are placed.

According to the invention,
said facility comprises at least one first linear conveyor, which defines a conveying axis along which a plurality of processing stations are arranged, said first conveyor having an upstream end and a downstream end,
at least some of said processing stations being identical so that the fowl of a single first container in motion between said upstream and downstream ends of said at least one first conveyor can receive the same processing by being shared across the various identical processing stations,
at least each one of said identical processing stations comprising a chute for conveying fowl thus processed from said corresponding processing stations to second containers,
said facility comprising stationary supports for supporting said second containers, which are arranged below said corresponding first conveyor, said supports also being placed level with or substantially level with a second conveyor located under said corresponding first conveyor, so that each second container can be moved, when it is full, from its stationary support to said second conveyor in order to be discharged.

By distributing the processing of newly hatched chicks over several identical stations, the original design of this facility makes it possible to achieve very fast rates, typically greater than 12,000 chicks per hour and more, while also being safer for said chicks.

It is also observed that the chicks are subjected to fewer movements and fewer impacts, and as a result are less stressed. Studies have demonstrated that stress in a chick can make its vaccination less effective.

The term “fowl” is understood here to mean any avian species, such as fowl from the class of Aves, that is, vertebrates which are feathered, winged, bipedal, endothermic (warm-blooded) and can lay eggs.

In the context of the present invention, the term more particularly refers to birds of economic and/or agronomic interest, such as poultry (for example, chickens, turkeys, hens, guinea fowl, quails, partridge, and pigeons), migratory fowl (for example, ducks and geese) and ornamental birds (for example, swans, parrots, and parakeets).

The first and second conveyors are linear conveyors for moving said containers, which define conveying axes. For example, these conveyors are belt or roller conveyors.

In a known manner, the terms “upstream” and “downstream” will be defined with respect to the direction of movement of the trays on the conveyor, the trays of course moving from upstream to downstream.

Preferably, the downstream end of said second conveyor is placed after the downstream end of said first conveyor in order to offset the outlet of said facility relative to said first conveyor.

Advantageously, the number of identical processing stations comprising a chute is determined so that all of the fowl located in a first container, placed at the upstream end of said first conveyor, are completely processed when it arrives at said downstream end of said first conveyor.

Based on the number of identical processing stations that the present facility contains, the observed rate may reach 50,000 live fowl/hour and more.

The chutes are arranged laterally to the first conveyor. According to a particular embodiment of this facility, in order to process newly hatched fowl at high speeds, it comprises at least two first conveyors arranged parallel to one another.

Preferably, these processing stations are placed opposite.

Preferably, said first conveyors are spaced apart by a distance such that said facility comprises a single second conveyor located under said first conveyors.

Thus, a more compact facility is advantageously obtained, which is therefore less bulky.

According to another particular embodiment of this facility, in order to process newly hatched fowl at a high speed, the width of said first conveyor is determined so that fowl transported in a container passing right next to an operator placed at one of said processing stations are accessible to be grasped without this operator having to extend their arm.

Advantageously, said first conveyor is placed at a height of at least 800 mm, and even better still at a height of at least 900 mm relative to a flat floor receiving said facility. For example, this height can be between 800 mm and 1100 mm.

According to yet another particular embodiment of this facility for high-speed processing of newly hatched fowl, the upstream end of said facility is intended to receive first containers comprising newly hatched fowl and debris to be sorted resulting from the hatching in order to allow the manual separation of these fowl and this debris.

According to yet another particular embodiment of this facility for high-speed processing of newly hatched fowl, each of the identical processing stations comprises a device for injecting at least one veterinary product into fowl and other similar birds.

According to yet another particular embodiment of this facility for high-speed processing of newly hatched fowl, each chute has an open upper end and a lower end shaped to define an intake with a gentle slope opening onto a second container placed on its stationary support.

According to yet another particular embodiment of this facility for high-speed processing of newly hatched fowl, it comprises means for conveying empty second containers to supply each of the identical processing stations.

Preferably, said conveying means consist of a linear inclined roller conveyor, which makes it possible to slide second empty containers along its movement axis by gravity.

According to yet another particular embodiment of this facility for high-speed processing of newly hatched fowl, said at least one first conveyor which conveys the fowl has a constant conveying speed of between ten (10) and twenty (20) m/min based on the desired rate based on the desired rate. Preferably, this conveying speed is fifteen (15) m/min.

Typically, said facility is configured to have a rate of at least 12,000 fowl/h, and even better still 50,000 fowl/h.

Preferably, the conveying speed is determined so that the movement duration of a batch of chicks at a processing station is greater than or equal to the duration of the operational processing phase on said corresponding processing station.

Thus, when this movement duration is greater than the duration of the operational processing phase on the corresponding processing station, the same operator has the possibility of manually grasping and processing more than one living fowl from the same first container.

According to yet another particular embodiment of this facility for high-speed processing of newly hatched fowl, it comprises a device for detecting the filling of the container, which transmits measurement signals that are processed by a processing unit, said processing unit being connected to an alarm device to transmit an end-of-filling signal and/or to move an end-of-travel flap placed at the end of the chute, the movement of said flap allowing said chute to send a fowl sliding along the latter to a different second container.

For purely illustrative purposes, the device for detecting filling of the container is an optical device configured to view the entire container.

For example, the processing unit is a microprocessor. It comprises software adapted to determine the fill rate of the second imaged container from images acquired by the detection device.

It is also possible to use the counting system of the device for injecting at least one veterinary product into fowl and other similar birds, to control the filling of the containers. A wireless communication protocol such as Zigbee allows the facility to have access to the vaccination counter of the device for injecting at least one veterinary product.

Preferably, said processing unit sends a signal and/or pivots an end-of-travel flap when the filling of said container reaches at least 90%, and better still at least 95% of its maximum capacity.

Advantageously, it comprises, at each stationary support intended to receive a second container, a device for moving a second container from its stationary support to a loading zone on said second conveyor wherein said second container thus moved is driven by said second conveyor.

By way of example, this device for moving a second container is a mechanism for driving the second container, such as an endless belt or a pusher movable between a rest position and a deployed position wherein it is placed in said loading zone of the second conveyor.

Advantageously, this facility further comprises at least one presence sensor configured to detect the presence of a second container in the loading zone during the movement of a second container from its stationary support to the second conveyor, this second presence sensor being further configured to stop said second conveyor or slow said second conveyor when a second container is already present in said loading zone.

Preferably, this presence sensor is a photoelectric cell.

According to yet another particular embodiment of this facility for high-speed processing of newly hatched fowl, it comprises a device for spraying at least one fluid such as a vaccine, said spraying device being placed at the downstream end of said second conveyor for dispensing droplets of fluid onto the newly hatched fowl moving into second containers, said facility further comprising a system for managing the second containers in motion on said second conveyor, said management system being configured to guarantee the processing of a single second container at the same time by said spraying device.

Advantageously, this container management system placed upstream of the spraying device guarantees that a single container is placed at the same time under the spraying device for the processing of its contents. It is thus ensured that there is no waste of veterinary fluid, while guaranteeing efficient processing of each container.

According to yet another particular embodiment of this facility for high-speed processing of newly hatched fowl, said management system comprises a control unit and two pairs of blockers actuated by actuators to brake two second containers immediately adjacent on said second conveyor and placed upstream of said fluid spraying device.

For example, each actuator is a hydraulic jack for moving a blocker from an inactive position to an active position.

According to yet another particular embodiment of this facility, in order to process newly hatched fowl at high speeds, said spraying device comprises a fluid supply circuit comprising a syringe.

The volume of this syringe advantageously determines the dose of fluid to be dispensed in the form of droplets by the spraying device.

According to yet another particular embodiment of this facility for high-speed processing of newly hatched fowl, said spraying device comprises at least one spraying station comprising several spray nozzles, said nozzles of each station being arranged to dispense a fluid in the form of droplets toward the surface of a second container conveyed by said second conveyor under said station.

For purely illustrative purposes, this spraying device may comprise two separate spraying stations, a first of these stations being configured to deliver a mist of droplets of a liquid to be sprayed and the second station being configured to dispense droplets of a gel, such as a soft gel or a fluid having a viscosity of between 50 and 2000 cps at 20° C.

At each of these stations, the delivered droplets are advantageously of uniform or substantially uniform size.

Purely by way of illustration, the first fluid is an aqueous composition containing a vaccine.

This gel may comprise a coloring agent to visually inspect the uniform distribution of the drops on the open tray

### BRIEF DESCRIPTION OF THE DRAWINGS

Other advantages, aims and particular features of the present invention will become apparent from the following description, made, for explanatory purposes and in no way limiting, with reference to the appended drawings, in which:

FIG. 1 is a schematic top view of a facility for processing chicks according to a particular embodiment of the present invention, this facility here comprising eight (8) identical processing stations;

FIG. 2 is a first perspective view of the processing facility of FIG. 1;

FIG. 3 is an enlarged view of the upstream end of the processing facility of FIG. 1 showing the sorting zone of the trays coming from the hatchers and the identical first stations for vaccination of the newly hatched chicks;

FIG. 4 is a partial and enlarged view of the downstream end of the processing facility of FIG. 1 showing the outlet of the facility;

FIG. 5 is a top view of the downstream end of the second conveyor in a facility for processing chicks according to another embodiment of the present invention, this facility comprising a tray management system to ensure uniform processing of the chicks in each tray by a spraying device;

### DESCRIPTION OF EMBODIMENTS

The drawings and the following description essentially contain elements of a certain nature. They may therefore not only serve to better understand the present invention, but also contribute to its definition, where appropriate.

First, it should be noted that the figures are not to scale.

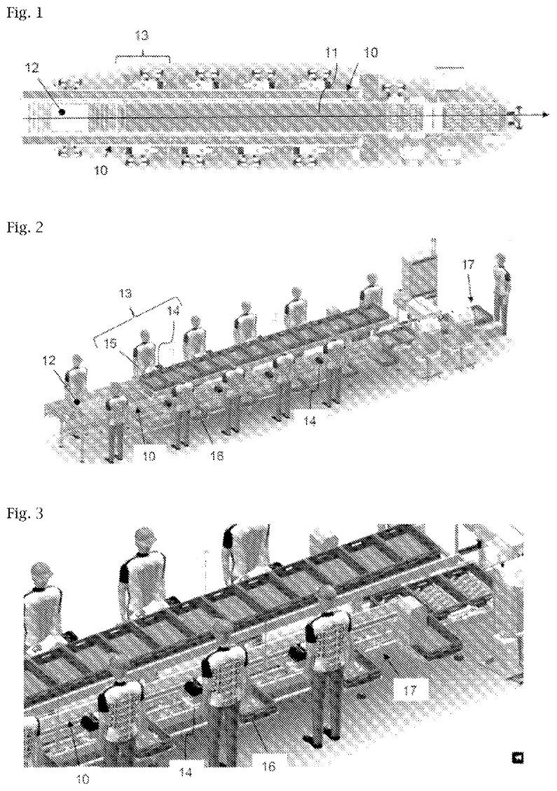

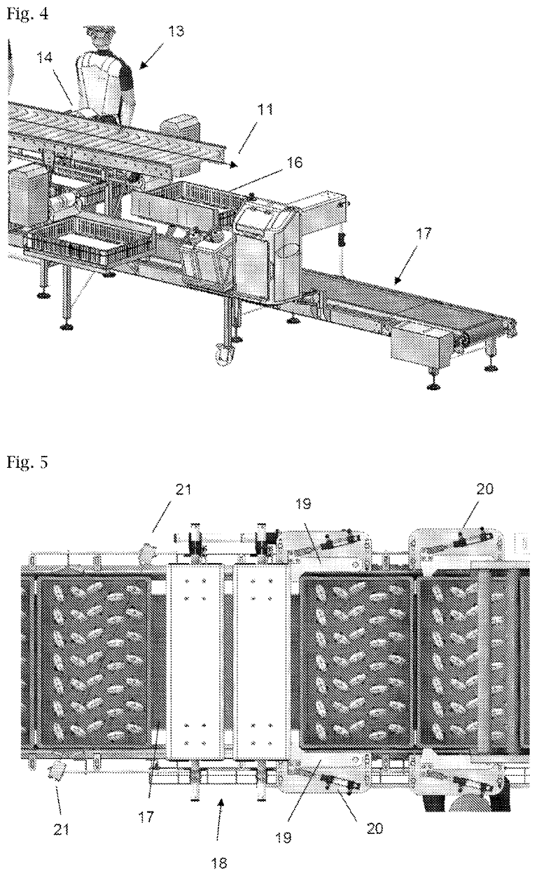

FIGS. 1 to 4 schematically and partially show a device for high-speed

processing of chicks according to a particular embodiment of the present invention.

This facility comprises two first conveyors 10 having an upstream end and a downstream end, these first conveyors 10 being intended to receive, at their upstream end, chicks coming from first containers, or baskets, wherein the newly hatched chicks to be processed are placed for their transportation.

These first conveyors 10, which are linear, define a conveying axis 11 along which several processing stations are arranged and in front of which the chicks are moved.

Advantageously, these first conveyors 10 being only linear, the chicks are subjected to less stress than with the facilities of the state of the art.

At the upstream end of the facility, two facing processing stations are placed, which define a manual sorting zone 12 of the baskets.

Indeed, after hatching, the baskets contain not only chicks but also clears, that is, non-fertilized eggs, unhatched eggs, that is, eggs containing dead embryos and pieces of shells of various sizes.

Personnel are therefore necessary to manually sort the baskets and remove as much waste as possible, in particular unhatched or unfertilized eggs that would otherwise risk exploding subsequently in the basket.

After these first sorting stations, eight identical processing stations 13 are arranged, which are distributed in pairs, each defining a handling area for the chicks moving on the first conveyors 10.

The number of identical processing stations 13 guarantees that all the chicks coming from the same basket and in motion between said upstream and downstream ends of these first conveyors 10 will receive the same processing.

The chicks coming from the same basket are thus transported by the

first conveyors 10 so that, when they pass in front of a handling area, the operators of the corresponding identical processing stations 13 grasp a certain number of chicks, one at a time, to inject them with a vaccine.

When the remainder of the chicks from the same basket move away to move toward the immediately following handling area located downstream, the operators cease to process these chicks in order to process chicks from a new basket and arriving within their reach in their handling area.

These identical processing stations 13, which are placed laterally to the first conveyors by being arranged opposite, are configured here for the administration of an injectable medicament or vaccine.

Each processing station thus comprises an apparatus 14 for administering a medicament or a vaccine to a chick by subcutaneous injection.

Each of these identical processing stations 13 further comprises a chute 15 for conveying chicks thus processed from the corresponding processing station to a second basket 16.

The trough of the chute 15 wherein the chick is introduced advantageously has a dimension adapted to avoid/limit the fall of the chick.

Each of the apparatuses 14 for administering a treatment or a vaccine to a chick can also be connected by a radio network with the automated device to have access to the number of injections done and to manage the filling rate in addition to the counting sensors in the chutes 15.

The facility comprises stationary supports (not shown) to support these second baskets 16, which are placed below the first conveyor 10.

These stationary supports are also placed level with or substantially

level with a second conveyor 17 located under the first conveyor 10, so that each second basket, when filled, can be moved from its stationary support to said second conveyor 17 for discharge.

FIG. 5 is a top view of the downstream end of the second conveyor 17 in a facility for processing chicks according to another embodiment of the present invention.

The elements of the processing facility of FIG. 5 bearing the same references as those of the processing apparatus shown in FIGS. 1 to 4 depict the same objects, which will not be disclosed again below.

The facility of FIG. 5 differs from the one shown in FIGS. 1 to 4 in that it comprises a spray ramp 18 and a system for managing the baskets transported on the second conveyor 17, this system making it possible to regulate the baskets in order to guarantee homogeneous processing of the chicks in each basket by the spray ramp 18.

This ramp comprises a plurality of spray nozzles for dispensing droplets of fluid, which are mounted above the belt of the second conveyor 17.

These spray nozzles are supplied by a supply circuit comprising a syringe to define a dose of a fluid to be dispensed, such as a vaccine.

The syringe is supplied by a vaccine container equipped with a stirring mechanism for mixing the vaccine and the diluent with controlled stirring.

Considering the fact that the filling of this syringe takes a certain time, the baskets cannot continuously pass under the spray ramp 18.

The processing facility therefore comprises two pairs of blockers arranged laterally to the second conveyor 17, each blocker 19 being actuated by an actuator 20, here a pneumatic jack.

These pairs of blockers are arranged so that each pair of blockers slows down, or else brakes, a basket moving on the second conveyor 17. Since these pairs of blockers are spaced apart so that two immediately adjacent baskets, or baskets placed one behind the other, on the belt of the second conveyor 17 are stopped.

The movement of these pairs of blockers between their inactive, or withdrawn, position and their active, or blocking, position is managed by two (2) pairs of optoelectronic sensors 21, located before and after the spray ramp 18.

The pair of first sensors placed upstream of, or in front of, the spray ramp 18 in the direction of travel of the baskets is used to detect the first basket, thus controlling the opening of the first pair of blockers.

The second pair of blockers acts in the reverse manner, that is, it is closed when the first pair of blockers is open, and vice versa.

The second pair of sensors is used to detect the saturation of the line, so that no basket remains immobilized under the spray ramp 18, thus risking receiving too much vaccine.

Depending on the type of basket, the configuration of the blockers/sensors as well as their type may vary.

In operation, a first basket comes into abutment against the first pair of blockers; the first pair of sensors placed before the spray ramp 18 gives the information that a basket is available and waiting.

If the vaccination ramp is ready, that is, its syringe is filled, information is given and the first pair of blockers enters the inactive position, that is, it opens to allow the basket to pass.

At the same time, the second pair of blockers closes to block the basket transported by the second conveyor 17, which comes after the first basket.

Once the first basket has passed the first pair of sensors located upstream of the spray ramp 18, the blockers of the first pair go from their inactive position to their active position, that is, the first pair of blockers closes again and the second pair of blockers opens again, or enters the inactive position, and the cycle begins again.

If the pair of sensors 21 placed at the sprayer outlet detects an immobilized basket, the system is blocked, preventing a basket from remaining under the spray ramp 18.

1. A facility for high-speed processing of newly hatched fowl, said facility having an upstream end and a downstream end, said facility being intended to receive, at its upstream end, first containers wherein said live newly hatched fowl are placed, characterized in that
said facility comprises at least one first linear conveyor, which defines a conveying axis along which a plurality of processing stations are arranged, said first conveyor having an upstream end and a downstream end,
at least some of said processing stations being identical so that the fowl of a single first container in motion between said upstream and downstream ends of said at least one first conveyor can receive the same processing by being shared across the various identical processing stations,
at least each one of said identical processing stations comprising a chute for conveying fowl thus processed from said corresponding processing stations to second containers,
said facility comprising stationary supports for supporting said second containers, which are arranged below said corresponding first conveyor, said supports also being placed level with or substantially level with a second conveyor located under said corresponding first conveyor, so that each second container can be moved, when it is full, from its stationary support to said second conveyor in order to be discharged.

2. The facility for processing fowl according to claim 1, characterized in that it comprises at least two first conveyors arranged parallel to one another.

3. The facility for processing fowl according to claim 2, characterized in that said first conveyors are spaced apart by a distance such that said facility comprises a single second conveyor located under said first conveyors.

4. The facility for processing fowl according to claim 1, characterized in that the upstream end of said facility is intended to receive first containers comprising newly hatched fowl and debris to be sorted resulting from the hatching in order to allow the manual separation of these fowl and this debris.

5. The facility for processing fowl according to claim 1, characterized in that each of the identical processing stations comprises a device for injecting at least one veterinary product into fowl and other similar birds.

6. The facility for processing fowl according to claim 1, characterized in that each chute has an open upper end and a lower end shaped to define an intake with a gentle slope opening onto a second container placed on its stationary support.

7. The facility for processing fowl according to claim 1, characterized in that it comprises means for conveying empty second containers to supply each of the identical processing stations.

8. The facility for processing fowl according to claim 7, characterized in that said conveying means consist of a linear inclined roller conveyor, which makes it possible to slide second empty containers along its movement axis by gravity.

9. The facility for processing fowl according to a claim 1, characterized in that said at least one first conveyor which conveys the fowl has a constant conveying speed of between 10 and 20 m/min based on the desired rate.

10. The facility for processing fowl according to claim 1, characterized in that it comprises a device for detecting the filling of the container, which transmits measurement signals that are processed by a processing unit, said processing unit being connected to an alarm device to transmit an end-of-filling signal and/or to move an end-of-travel flap placed at the end of the chute, the movement of said flap allowing said chute to send a fowl sliding along the latter to a different second container.

11. The facility for processing fowl according to claim 10, characterized in that said processing unit sends a signal and/or pivots an end-of-travel flap when the filling of said container reaches at least 90%, and better still at least 95% of its maximum capacity.

12. The facility for processing fowl according to claim 1, characterized in that it comprises a device for spraying at least one fluid such as a vaccine, said spraying device being placed at the downstream end of said second conveyor for dispensing droplets of fluid onto the newly hatched fowl moving into second containers, said facility further comprising a system for managing the second containers in motion on said second conveyor, said management system being configured to guarantee the processing of a single second container at the same time by said spraying device.

13. The facility for processing fowl according to claim 12, characterized in that said management system comprises a control unit and two pairs of blockers actuated by actuators to brake two second containers immediately adjacent on said second conveyor and placed upstream of said fluid spraying device.

14. The facility for processing fowl according to claim 13, characterized in that said spraying device comprises a fluid supply circuit comprising a syringe.

15. The facility for processing fowl according to claim 14, characterized in that said spraying device comprises at least one spraying station comprising several spray nozzles, said nozzles of each station being arranged to dispense a fluid in the form of droplets toward the surface of a second container conveyed by said second conveyor under said station.
